(19) United States
(12) Patent Application Publication
(10) Pub. No.: US 2011/0199765 A1
(43) Pub. Date: Aug. 18, 2011

(54) Linear LED Lamp

(75) Inventor: Gregory Brian Simons, Loganville, GA (US)

(73) Assignee: ABL IP Holding LLC, Conyers, GA (US)

(21) Appl. No.: 12/704,628

(22) Filed: Feb. 12, 2010

(51) Int. Cl. F21V 1/00

(52) U.S. Cl. 362/235

(57) ABSTRACT

An LED-based lamp includes a linearly elongated body having a reflective interior surface defined by a top portion and side portions. An array of LEDs is mounted to at least one of the side portions and positioned such that its emitted light is directed into the linearly elongated body, where it is diffused and emitted from the lamp uniformly. In other embodiments, arrays of LEDs are mounted to both of the side portions. The interior of the body is an open cavity. A transparent cover is optionally attached to the body.

### FIELD OF THE INVENTION

This invention relates to light fixtures, particularly light emitting diode-based light sources for use as an alternative to linear fluorescent lamps.

### BACKGROUND OF THE INVENTION

Traditional light fixtures presently used in a typical office environment comprise a troffer with at least one fluorescent lamp and a lens having prismatic elements for distributing the light. Such light fixtures may also use parabolic reflectors to provide a desired light distribution. The fluorescent lamp has long been the light source of choice among lighting designers in many commercial applications, particularly for indoor office lighting. A description of such a fluorescent light fixture may be found in U.S. Pat. No. 7,229,192, the contents of which are hereby incorporated by reference.

For many years the most common fluorescent lamps for use in indoor lighting have been the linear T5 (⅝ inch diameter), T8 (1 inch diameter), and the T12 (1½ inch diameter). Such bulbs are inefficient and have a relatively short lamp life. Thus, efforts have been made to identify suitable alternative illumination sources for indoor office lighting applications. Light emitting diodes (“LEDs”) have been identified as one alternative to traditional fluorescent bulbs.

An LED typically includes a diode mounted onto a die or chip, where the diode is surrounded by an encapsulant. The die is connected to a power source, which, in turn, transmits power to the diode. An LED used for lighting or illumination converts electrical energy to light in a manner that results in very little radiant energy outside the visible spectrum. LEDs are extremely efficient, and their efficiency is rapidly improving. For example, the lumen output currently obtained by 20 LEDs may soon be obtained by only 10 LEDs. It would thus be desirable to provide an LED-based alternative to traditional linear fluorescent lamps.

### SUMMARY OF EMBODIMENTS OF THE INVENTION

An LED-based lamp includes a linearly elongated body having a reflective interior surface defined by a top portion and side portions. The interior of the body is an open cavity. An array of LEDs is mounted to at least one of the side portions and positioned such that its emitted light is directed into the linearly elongated body, where it is diffused and emitted from the lamp uniformly.

In other embodiments, arrays of LEDs are mounted to both of the side portions.

In some embodiments, a transparent cover is attached to the body.

### BRIEF DESCRIPTION OF THE DRAWINGS

FIG. 1 is an end view of an LED lamp according to one embodiment of the invention.

FIG. 2 is a perspective view of an LED lamp according to the embodiment of FIG. 1 with the LEDs removed.

FIG. 3 is an end view of an LED lamp according to another embodiment of the invention.

FIG. 4 is a perspective view of an LED lamp according to the embodiment of FIG. 3.

### DETAILED DESCRIPTION OF EMBODIMENTS OF THE INVENTION

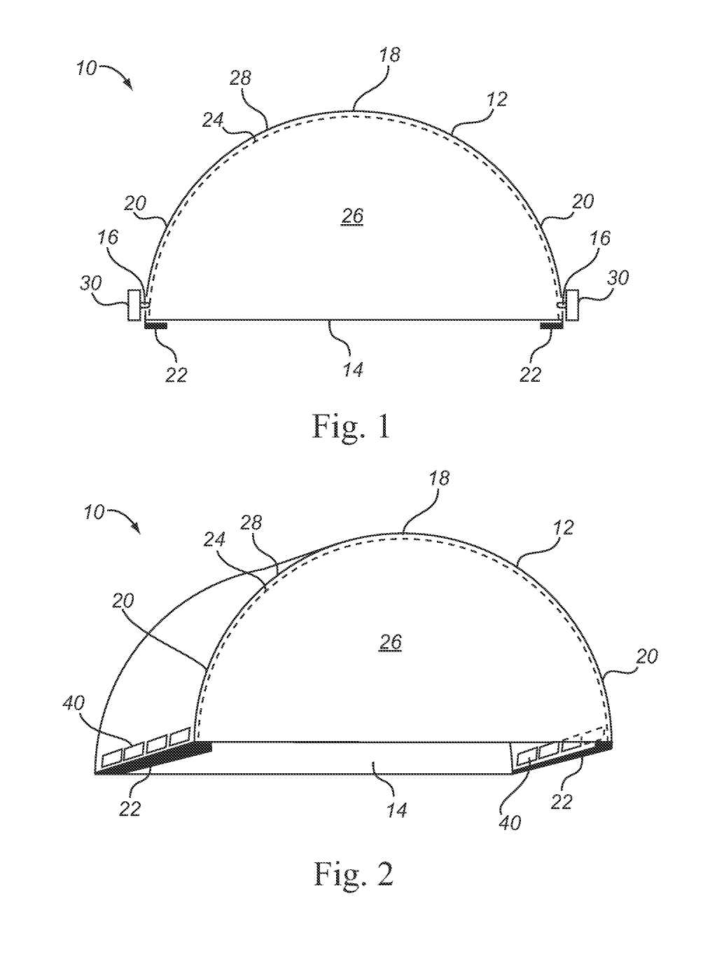

In one embodiment of the present invention, as shown in FIGS. 1 and 2, a lamp 10 includes a housing 12 and optionally a cover 14. A plurality of light emitting diodes (“LEDs”) 16 extend along at least a portion of the length of the housing 12.

The LEDs 16 may be single-die or multi-die light emitting diodes, DC or AC, or can be organic light emitting diodes (“O-LEDs”). The lamp 10 need not use only white LEDs 16. Rather color or multicolor LEDs 16 may be provided. Nor must all of the LEDs 16 within the lamp 10 be the same color.

The housing 12 may be formed of any thermally conductive material, including but not limited to aluminum, plastic or a highly reflective material as discussed below. In some embodiments, the housing 12 is extruded in any desired length. The housing 12 has a top portion 18 and side portions 20 that define an exterior surface 28 and an interior surface 24. While illustrated in FIG. 1 as substantially semi-circular and in FIG. 2 as half of a cylinder, the housing 12 may have any shape including but not limited to linear, curved, parabolic, arched, rectilinear, rhombic, and triangular.

The LEDs 16 are affixed to at least one of the side portions 20 of the housing 12 so that their emitted light is directed into the housing 12. The LEDs 16 may be individually affixed to the housing 12 or can be affixed to the housing 12 as a linear array, or bank, of LEDs 16. While the LEDs 16 may be directly affixed to the housing 12 (such as with the use of chip-on-board technology), in one embodiment the LEDs 16 are first mounted on a printed circuit board (“PCB”) 30, which is then affixed to the housing 12. The PCB 30 can be, among other things, metal core board, FR4 board, CHM1 board, etc. Any number of LEDs 16 may be mounted on the PCB 30 at any number of locations.

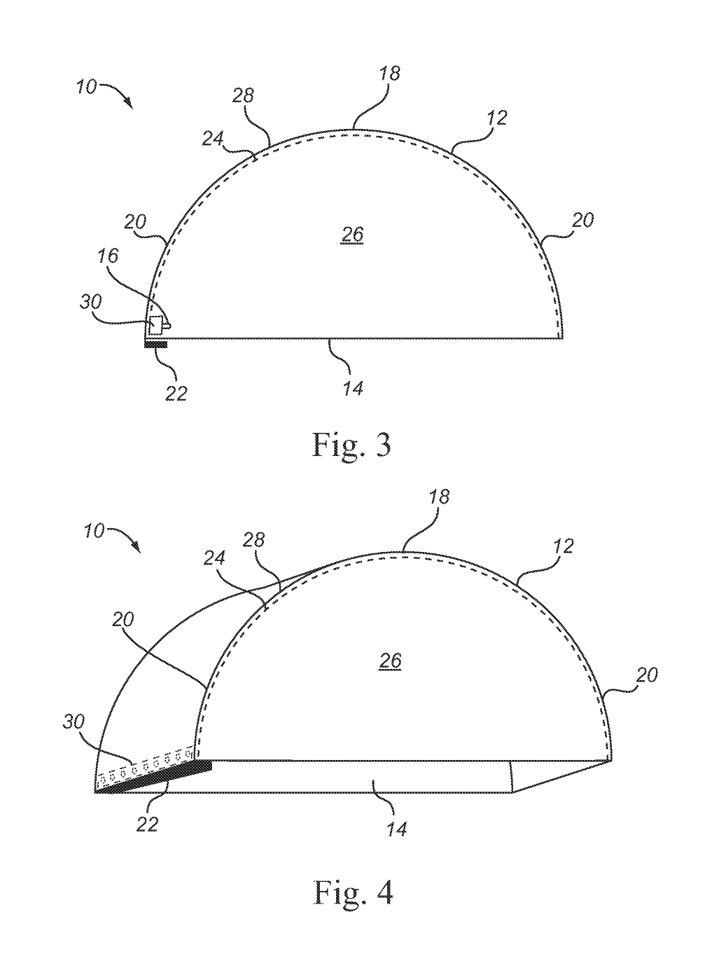

The PCB 30 may be mounted (directly or indirectly) on the exterior surface 28 or the interior surface 24 of the housing 12. In one embodiment (see FIG. 2), a side portion 20 of the housing 12 is provided with a plurality of apertures or “windows” 40 that extend through the housing 12, and the PCB 30 is mounted to the exterior surface 28 of the housing 12 so that each LED 16 is aligned with a window 40 and thus light emitted from the LEDs 16 is able to enter the housing 12. In an alternative embodiment (see FIGS. 3 and 4), the PCB 30 may be mounted to the interior surface 24 of a side portion 20 of the housing 12 so that light emitted from the LEDs 16 is emitted into the housing 12.

A cover 14 is optionally affixed between the side portions 20, and can be permanently or removably attached to the housing 12. The cover 14, if used, diffuses light emitted from the LEDs 16. The cover 14 may have any shape including curved, rectilinear, parabolic, or any other appropriate shape to diffuse light emitted from the LEDs 16 as desired. The cover 14 may be formed of plastic or any other suitable material that allows a sufficient amount of light to escape the housing 12, and could optionally contain micro-optics, Fresnel optics or other beam-shaping components to direct the light as desired.

The cover 14 is connected to the side portions 20 via any appropriate mechanical or chemical means. In some embodiments, the cover 14 can snap-fit over the edges of the side portions 20. In other embodiments, the cover may be attached to the side portions 20 by mechanical fasteners.

At least a portion (or the entirety) of the interior surface 24 of the housing 12 preferably has extremely high surface reflectivity, preferably, but not necessarily, between 96%-99.5%, inclusive and more preferably 98.5-99%. To achieve the desired reflectivity, in one embodiment the interior surface 24 of the housing 12 is coated with a diffuse, reflective material, including, but not limited to, reflective paints. Alternatively, the interior surface 24 of the housing 12 could include a layer of a reflective flexible sheet of material such as one or more of the materials sold under the tradenames GL-22, GL-80, GL-30 or Optilon™, all available from DuPont. Alternative materials include Miro® reflective aluminum materials, available from Alanod, and micro cellular polyethylene (“MCPET”), available from Furukawa. Specular materials would also be suitable. The reflective material may be substantially glossy or substantially flat. In one example, the reflective material is preferably matte white to diffusely reflect incident light. Other embodiments may utilize textured or colored paints or impart a baffled shape to the interior surface 24 to obtain a desired reflection. Alternatively, the housing 12 itself can be formed from a reflective material so that the interior surface 24 of the housing 12 need not be separately treated to attain the desired reflectivity. The interior portion 26 of the lamp 10 is preferably, but not necessarily, an open cavity filled with ambient air.

As illustrated in FIGS. 1-4, in some embodiments a shield (or shields) 22 extends along a portion of the length of the housing 12 adjacent the LEDs 16. Shield 22 is positioned and designed to block the light emitted from the LEDs from escaping directly out of the lamp 10 and thus causing glare issues. The shield 22 may be formed of any thermally conductive material, including but not limited to aluminum. The shield could also be formed from, or include as a layer, a highly reflective material to preserve as much light output as possible, directing it back into the cavity where it could be diffused and emitted. This highly reflective material could be diffuse or specular and, for example, white or silver. Exemplary materials for a highly reflective material for the shield 22 (or for the shield 22 itself or as a layer applied to the shield 22) include Optilon™, composite reflective films available from DuPont, Miro® reflective aluminum materials, available from Alanod, and micro cellular polyethylene (“MCPET”), available from Furukawa. The shield 22 could be integrally formed with the housing 12 or could be separately attachable to the housing 12 with a bracket, clamp or other traditional mounting apparatus (not illustrated).

During operation, light from the LEDs 16 is directed into the housing 12, reflects diffusely off the reflective interior surface 24 of the housing 12 and then propagates through optional cover 14 and out of the lamp 10. Thus, although the lamp 10 uses point sources of light, the light exiting the lamp 10 is of uniform luminance.

Although LEDs generate less heat than incandescent bulbs of comparable light output, heat dissipation is still a consideration, particularly when several LEDs are located close to one another. Accordingly, a heat sink (not illustrated) can optionally be used in the lamp 10 (such as coupled to the PCB 30) to dissipate heat generated by LEDs 16. The housing 12 also promotes heat dissipation. It will be recognized that the interior portion 26 of the lamp 10 may provide sufficient heat dissipation characteristics without the need for a heat sink, particularly if the lamp 10 does not include a cover 14 and thus heat is able to exit the interior portion 26 of the lamp 10.

Embodiments of the LED-based lamps described herein can be used in a wide variety of lighting applications to replace traditional fluorescent bulbs, such as accent lighting applications, or—if the amount of light propagating out of the lamp 10 is sufficient—area lighting applications. Because the housing 12 may be extruded to be of any length, the lamps 10 disclosed herein may easily be tailored to accommodate the dimensions of traditional fixtures and thus may be easily retrofitted into such fixtures.

Retrofitting of existing fluorescent fixtures would require electrical and mechanical modifications to the fixture. For example, the ballast of an existing fixture could be replaced with an LED driver to power the LEDs. Moreover, the fixture would need to be adapted to mechanically support the LED lamp 10. A person skilled in the art could make the required electrical and mechanical modifications to retrofit an existing fluorescent fixture with embodiments of the LED lamps described herein.

The foregoing is provided for purposes of illustrating, explaining, and describing embodiments of the present invention. Further modifications and adaptations to these embodiments will be apparent to those skilled in the art and may be made without departing from the scope or spirit of the invention.

We claim:

1. A lamp comprising:
a linearly elongated body having a top portion, a first side portion, and a second side portion that define an interior surface and an exterior surface, wherein at least a portion of the interior surface comprises a reflective material; and
at least one array comprising a plurality of light emitting diodes mounted to the first side portion and positioned such that light emitted from the light emitting diodes is directed substantially into the body towards the interior surface.

2. The lamp of claim 1, wherein the body comprises at least one of aluminum, plastic, a composite reflective material, a reflective aluminum material, micro cellular polyethylene or combinations thereof.

3. The lamp of claim 2, wherein the body comprises aluminum and is extruded.

4. The lamp of claim 1, further comprising a transparent cover attached to the body.

5. The lamp of claim 1, further comprising a shield positioned relative to the plurality of light emitting diodes to substantially prevent light emitted from the light emitting diodes from escaping directly out of the body.

6. The lamp of claim 1, wherein the reflective material is incorporated into a layer that is painted onto, coated onto, or attached to the interior surface of the body.

7. The lamp of claim 6, wherein the reflective material is a composite reflective material, a reflective aluminum material, micro cellular polyethylene or combinations thereof.

8. The lamp of claim 1, wherein the body is formed from the reflective material.

9. The lamp of claim 1, wherein an interior portion of the linearly elongated body comprises an open cavity.

10. The lamp of claim 1, further comprising a heat sink coupled to the plurality of light emitting diodes for dissipating heat generated by the light emitting diodes.

11. The lamp of claim 1, wherein the at least one array comprises a first array and a second array, wherein the first array is mounted to the first side portion and wherein the second array is mounted to the second side portion.

12. The lamp of claim 1, wherein the at least one array is mounted to the exterior surface of the linearly elongated body.

13. The lamp of claim 12, wherein the linearly elongated body further comprises at least one window for receiving the plurality of light emitting diodes.

14. The lamp of claim 1, wherein the at least one array is mounted to the interior surface of the linearly elongated body.

15. A lighting fixture comprising the lamp of claim 1.

16. A lamp comprising:
a linearly elongated body having a top portion and side portions that define an interior surface, wherein the interior surface comprises a reflective material and an open cavity, wherein the reflective material is incorporated into a layer that is painted onto, coated onto, or attached to the interior surface of the body;
a transparent cover attached to the body; and
an array comprising a plurality of light emitting diodes mounted to one of the side portions and positioned such that light emitted from the light emitting diodes is directed substantially into the body and towards the interior surface.

17. A method for retrofitting an existing light fixture with a light emitting diode lamp, comprising:
removing an existing light source from the existing light fixture;
providing a light emitting diode lamp comprising:
a linearly elongated body having a top portion and side portions that define an interior surface, wherein at least a portion of the interior surface comprises a reflective material; and
an array comprising a plurality of light emitting diodes mounted to at least one of the side portions and positioned such that light emitted from the light emitting diodes is directed substantially into the body; and
installing the light emitting diode lamp into the existing light fixture.
